(19) United States
(12) Patent Application Publication
(10) Pub. No.: US 2004/0133669 A1
(43) Pub. Date: Jul. 8, 2004

(54) Event or polling driven DVB-T filter detection

(76) Inventors: Esa Jalonen, Espoo (FI); Matti Puputti, Turku (FI)

Correspondence Address: MORGAN & FINNEGAN, L.L.P., 345 Park Avenue, New York, NY, 10154-0053, US

(21) Appl. No.: 09/995,547

(22) Filed: Nov. 28, 2001

(51) Int. Cl. H04N 7/16; H04N 7/173; G06F 15/173

(52) U.S. Cl. 709/224; 725/25; 725/112; 725/113

(57) ABSTRACT

A method for eliminating the need for custom interfaces between client PC applications and DVB-T receivers. The method uses existing TCP/IP structure to provide details of all currently active connections, and uses a cross reference system on DVB-T SI to identify any filter state changes that are needed. This system obtains filter information by polling the UDP Listener Table or by detecting IGMP status changes. These methods are implemented in receiving terminals, and overcome significant limitations to current methods.

### FIELD OF THE INVENTION

This invention relates to the implementation of a filter in a digital broadcast receiver, and more particularly to a method to activate such a filter in a DVB-T receiver in a way that is independent from the client software desiring access to the data.

### BACKGROUND OF THE INVENTION

Digital video and audio signals, synchronized in the form of a program (or service), can be transmitted over a network as multicast data. In a multicast network, such as DVB-T, a transmitting terminal typically distributes data to the network so that any receiving node wishing to receive a given data service may subscribe to it. In this manner, the transmitting terminal does not establish point-to-point links between a plurality of receiving nodes; one copy of broadcasting data is transmitted, and multiple receivers each can view the same material. An advantage a multicast network protocol has over other data distribution network protocols is that the relatively large amount of data needed to transmit motion pictures or the like is only sent to switching nodes on the network once, and then forwarded to various receiving terminals along the network.

Each digital data service broadcast from the transmitting terminal is segmented into a Packetized Element Stream. In a multicast system, multiple data services are typically transmitted onto the same communication media or channel. Each transport stream packet in this channel contains header information and a payload with multicast service data, for instance, parts of a movie. Receiving terminals use the header information to reassemble the packets carrying the desired service and to discard unwanted packets.

While a multicast protocol eliminates the need for the transmitting terminal to manage multiple connections and reduces the need for the network to handle a flood of redundant data, multicast receiving nodes require a more sophisticated method to sort relevant data than do point-to-point network nodes. As discussed above, a large number of services may be multiplexed onto the same data channel, posing a significant load on the network protocol stack of each receiving terminal that must sort the data. A challenge for receiving nodes is to sort the plurality of available data packets and determine and accept desired data while ignoring unwanted packets.

The solution to deal with this limitation is for a receiving node to use a dual inspection to insure accurate delivery of packets. Tables located in each receiving node track information related to each packet, notably the program identifier (PID) and the DVB media access control (MAC) address. When client software at the receiving node initiates a request for a service, the receiver applies a filter to inspect a data channel for multicast data. The filter initially uses network interface hardware to examine the PID field of the header, which contains enough information to eliminate most unwanted packets. After a packet has been promoted into the protocol stack based on the information in the PID field, software examines the MAC address of each packet to determine if it is indeed part of the desired service. While this system is not perfect, it does accomplish a significant reduction in software packet analysis.

In order to successfully implement the packet selection process discussed above, the software of the receiving node must activate the filter as soon as the client requests a given service. Typically, such a filter is activated when client software communicates a request to the receiver via a programming interface, requiring each client application to be written specifically for DVB-T receiver purposes. Further, in order to avoid software analysis of unneeded packets and therefore to optimize receiver performance, filters must be removed as soon as they are no longer needed.

It is desirable to have a method to enable a DVB-T filter that is independent of special programming interfaces.

LEXICON

| | |
|---|---|
| DVB-T | Digital Video Broadcast-Terrestrial |
| IGMP | Internet Group Management Protocol |
| IP | Internet Protocol |
| MAC | Media Access Control |
| PID | Program identifier |
| SI | Service Information |
| SIT | Service Information table; note that this is |
| | not the table that stores the SI in the |
| | DVB standard. |
| UDP | User Datagram Protocol |

### SUMMARY OF THE INVENTION

The above-identified problems are solved and a technical advance is achieved in the art by providing a method for activating and removing a filter in a multicast network.

An exemplary method for activating a filter includes detecting the need for a multicast connection by analyzing a UDP Listener Table, creating and binding a socket to a port number, retrieving filter parameters from a SIT into a memory, and sending the filter parameters to a receiver. A corresponding method is used to detect the closure of a multicast connection and remove the filter with which the connection is associated.

In an alternate embodiment, an exemplary method for activating a filter includes detecting the need for a multicast connection by monitoring IGMP messages originating in the receiving node, creating and binding a socket to a port number, retrieving filter parameters from a SIT into a memory, and sending the filter parameters to a receiver. A corresponding method is used to detect the closure of a multicast connection and remove the filter associated with that connection.

In an alternated embodiment of the present invention, software is executed on a system that causes it to operate in a way that relates desired connections at a receiver to software executed on a client but not specially designed to communicate with the receiver. Another embodiment of the present invention interfaces mobile terminals to a receiver without regard to the client software to access the receiver's multicast content.

The inventive method has significant advantages over existing systems, as the linkage between the filter and the client machine is made through existing table structures. A connection such as this provides significant flexibility in use of client application, because special DVB-T specific interfaces are not needed for filtering to take place.

Other and further aspects of the present invention will become apparent during the course of the following description and by referring to the attached drawings.

### BRIEF DESCRIPTION OF THE DRAWINGS

FIG. 1a is a block diagram of an exemplary network wherein the present invention may be utilized.

FIG. 1B is a block diagram depicting the changes that take place to the packet at the DVB receiver in one embodiment of the present invention.

FIG. 2 is a block diagram exemplary of the process required for a receiving terminal to join a multicast group.

FIG. 3 is a block diagram exemplary of the process required for a receiving terminal to leave a multicast group.

FIG. 4 is a block diagram exemplary of the relationship between the UDP Listener Table and the SIT.

FIG. 5 is a process flow diagram depicting an exemplary embodiment of the invention using UDP Listener Table polling.

FIG. 6 is a process flow diagram depicting an exemplary embodiment of the invention using IGMP event detection.

### DETAILED DESCRIPTION

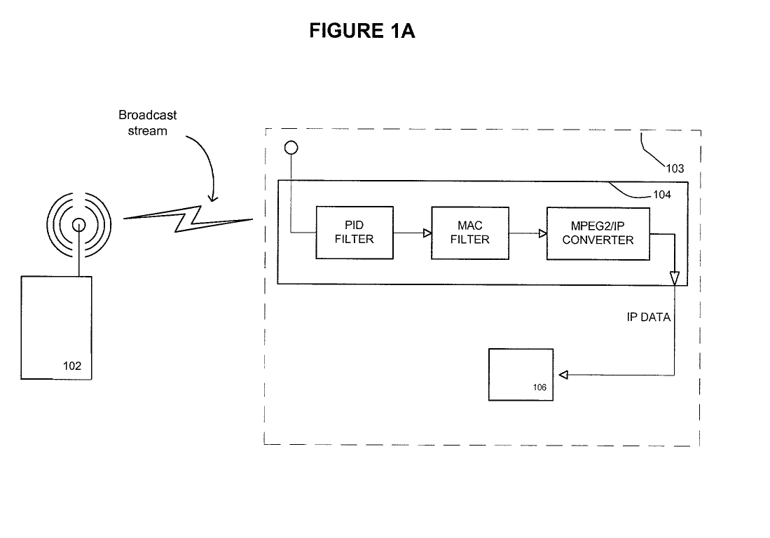

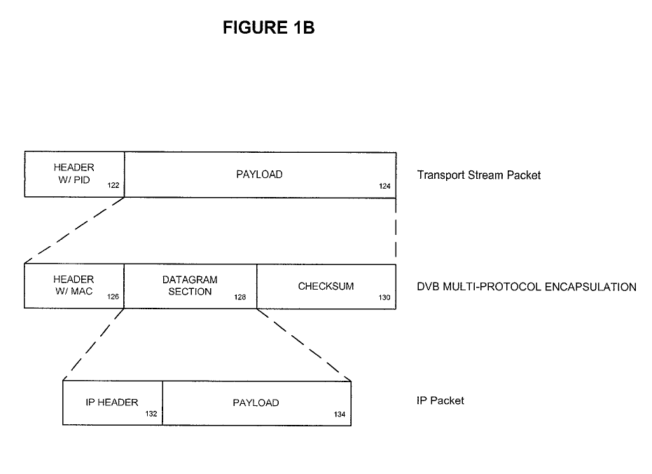

FIG. 1A depicts a basic multicast network having at least a transmitting terminal 102 such as a Datacast Server and a receiving node 103. In this embodiment, the receiving node includes a DVB-T Receiver 104 and a client machine 106. The client machine 106 may be a personal computer, a set-top box, or the like attached to a display for viewing the data being broadcast. Moreover, it is to be understood that in this type of network a plurality of receiving nodes typically are present. Multiple receiving nodes, however, are omitted from FIG. 1A for simplicity.

In a multicast network of the type shown in FIG. 1A, the transmitting terminal 102 divides each program into packets allowing a plurality of programs to be placed onto a common data channel. The transmitting terminal transmits a plurality of packets in the form of a Packetized Element Stream in which each packet includes filter parameters in the form of a Program Identifier (PID) and a DVB-Media Access Controller (MAC) address. The receiver 104 at the receiving node 103 identifies desired packets from a plurality of data packets on the multicast channel using filter parameters. In particular, packet identification is a two step process taking place at the receiver, where the first step is a rudimentary hardware selection and the second step is a positive identification in software.

FIG. 1B depicts the relationship between the packets utilized by the transport stream, the multi-protocol DVB encapsulation packets, and the IP packets sent by the receiver to the client machine. The transport stream packet 120 is a 188 byte packet containing a header of 4 bytes 122 and payload of 184 bytes 124; these are the packets sent by the DVB-T transmitter. When this packet is received, the receiver examines this transport stream packet using hardware, and selects each packet in the stream whose PID matches the criteria the filter has identified. The receiver then strips the transport stream information off the packet, typically in software, to access the DVB multi-protocol encapsulation packet. This packet contains a header that conveys a unique MAC address 126, a datagram section containing data 128, and a checksum section for error correcting purposes 130. The receiver examines the MAC address, and accepts all packets that are part of the desired program.

Using a two-stage filter of the type described minimizes load on the protocol stack of the receiver and the client, as hardware can quickly examine the PID. By this hardware analysis, a significant portion of unwanted packets are removed without entry into the protocol stack. Other methods of packet selection by receiving nodes are known in the art.

Once the receiver determines the DVB packet to be part of the desired program, the DVB encapsulation is stripped off to produce an IP packet. The IP packet is composed of a header 132 and a payload 134, and can be readily accepted by the client machine. The relationship between the three packets is depicted as descending from transport stream packet to IP in FIG. 1B.

Further, an alternate embodiment includes attaching a DVB-T receiver to a portable terminal, such as a personal digital assistant by means of a USB cable, or using a PCMCIA type DVB receiver in conjunction with a client PC. An alternate embodiment integrates the receiver into the client such as a mobile telephone including a DVB-T receiver and medial player.

In still another embodiment, a system of this type may be software that, when executed on a client PC having an interface to a DVB-T receiver, will automatically direct the receiver to subscribe to a given service.

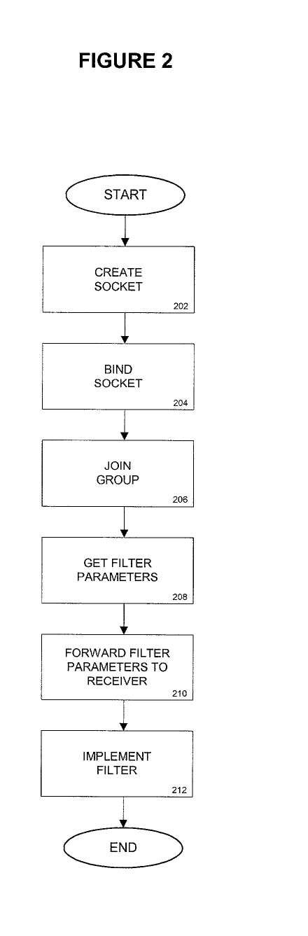

FIG. 2 demonstrates the process by which a receiving node requests access to a multicast stream and begins capturing information from that stream in accordance with one embodiment of the present invention. In step 202, the client machine opens a multicast IP socket for data retrieval when an application on the client machine requests multicast data. In step 204, the receiver binds this socket to a port number. At this point in the process, an entry to the UDP Listener Table is created.

The UDP Listener Table is a table that tracks each data connection the client machine currently has open. This table is populated with entries having information that allow a system to track incoming packet streams.

In one embodiment of the present invention, the service information table (SIT) tracks a variety of information for use in multicast data retrieval. In particular, the SIT tracks UDP port numbers, filter parameters for identifying incoming packets, and filter status indicating whether a filter is currently enabled. The information in this table is updated as needed, both from internal receiver state changes e.g., filter activation, and from service information carried by the network e.g., new available services.

In step 206, the receiving node joins a multicast group, typically by transmitting a ‘membership request’ IGMP packet to upstream switching nodes. In step 208, filter parameters are retrieved from a table that tracks multicast connections called the SIT, and forwarded, in step 210, to the receiver. In step 212, the receiver implements the filter using the filter parameters.

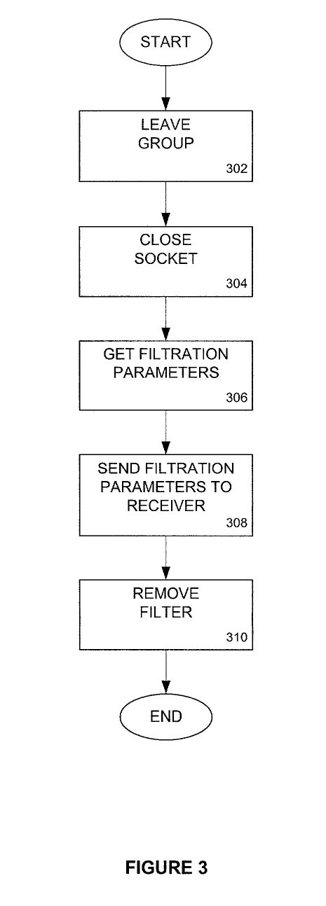

FIG. 3 demonstrates the process by which a receiving node ends its membership in a multicast group. In step 302, the client machine leaves the multicast group when the application accessing the data determines that the multicast connection is no longer needed. This is done, typically, by sending an IGMP ‘leave’ message to upstream switching nodes. In step 304, the client machine closes the socket and deletes the entry from the UDP listener table, thereby ending the connection between the client software and the multicast data stream. In step 306, filter parameters are again retrieved from the SIT. These parameters are forwarded to the receiver in step 308, which, in step 310, removes the filter.

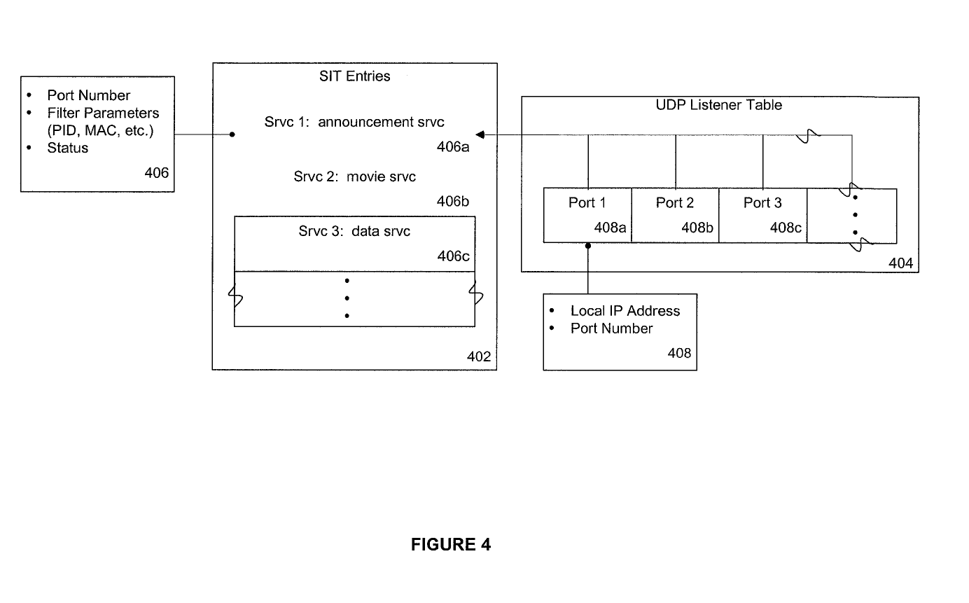

FIG. 4 shows the relationship between a SIT and a UDP Listener Table for use by the receiving node in accordance with one embodiment of the present invention.

The UDP Listener Table maintained by the client machine is typically used as an index of all incoming UDP signals and the local IP addresses the client machine has assigned to the signals. In accordance with one embodiment of the present invention, the relationship between the SIT and the UDP Listener Table is exploited to allow filters to be activated and removed without any special programming interface, as will be discussed.

Referring to FIG. 4, the SIT 402 contains a number of entries 406a, 406b, 406c, each corresponding to a data stream. Each entry 406 includes a port number, filter parameters of a multicast data stream, and the state, active or inactive, of any filter that is associated with that stream. The port numbers are typically 32 bits in length, the filter parameters include, but are not limited to, the PID and MAC. It will be understood by those skilled in the art that, although not shown in FIG. 4, the SIT may contain other data.

The UDP Listener Table 404 contains a number of entries 408a, 408b, 408c, each entry corresponding to a port that is currently active in the machine. Each entry 408 includes a local IP Address and a UDP port number. It will be understood by those skilled in the art that the UDP listener table may include other information.

Entries associated with multicast data in the UDP Listener Table are identified with a 0.0.0.0 value as their local IP address. As such, it is easy to identify all currently open multicast streams to which the receiver is connected by extracting all entries with this value from the UDP Listener Table. Multicast ports in the UDP Table can then be compared to multicast entries in the SIT, thereby allowing the receiver to determine the state of all multicast connections and identify whether to enable, remove, or ignore filters.

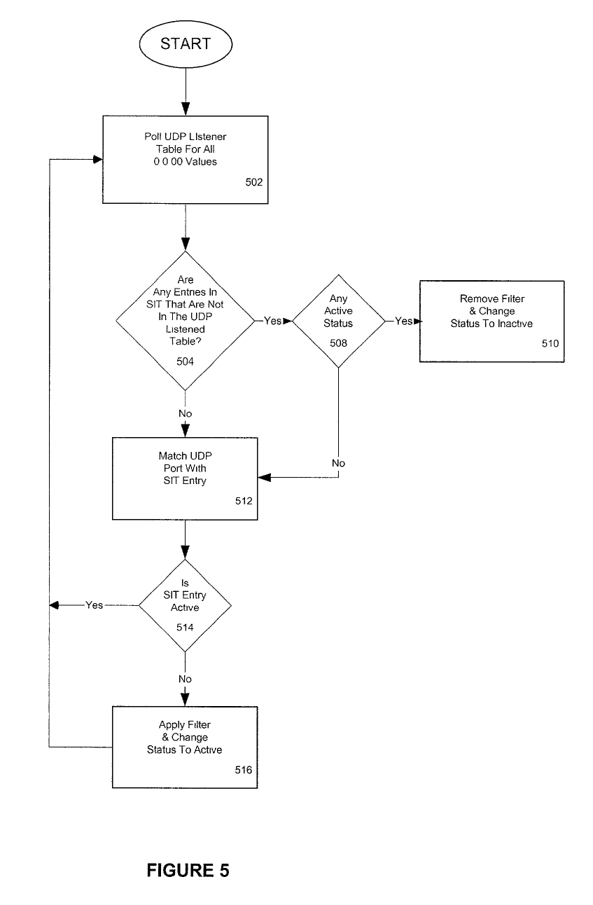

FIG. 5 is a flow chart illustrating an exemplary method by which a receiving node manages filters in accordance with one embodiment of the present invention.

In step 502, the UDP Listener Table is polled for a list of all entries that have 0.0.0.0 as their local IP address. Since polling of the UDP Listener Table is continuous, updates to filter status do not require any specialized trigger. In an alternate embodiment, the continuous examination of the UDP Listener Table is replaced by passively detecting the entry or removal to the UDP Listener Table of any local IP address that has a multicast local IP address value.

In step 504, the SIT is examined for entries that do not correspond to entries in the UDP list compiled in step 502. If there are entries in the SIT that do not correspond to those in the UDP list, in step 508, these SIT entries are examined to determine whether they have an ‘active’ status. SIT entries that are not in the UDP list but which have an active status are connections that have been closed and which are consequently no longer needed. In step 510, filters corresponding to those entries are removed and their status are reset to ‘inactive.’ This process, steps 504-510, is then repeated until it has been determined that all SI entries either correspond to a UDP entry or are ‘inactive.’

At that point, in step 512, all SI entries that match entries in the UDP list are scrutinized. In particular, in step 514, the status of the SI entries is examined. If the entry is ‘inactive,’ then a filter is applied in step 516, and the status is set to ‘active.’ If there are no inactive entries in the SI list corresponding to the UDP list, control is returned to step 502 and the filter management process is repeated. The above-described steps ensure that filters are removed quickly after the multicast connection is closed by the client, thereby minimizing unnecessary load on the system.

Sequencing in the present invention is not crucial to operation, and consequently the steps disclosed in FIG. 5 can be reordered. For example, UDP entries that match SI entries may be disposed of first (steps 512-516), with the removal step (step 510) located at the end of an iteration. Further, several of these steps may be processed in parallel, such that the removal step 510 occurs simultaneously with the filter application step (step 516). Moreover, a list of entries to be examined need not be generated, but rather the SI or FUDP entries may be processed one entry at a time.

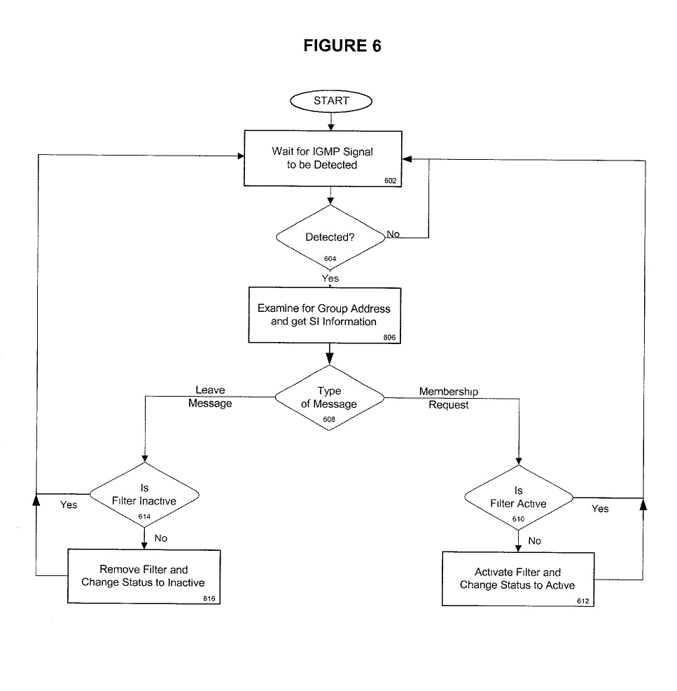

FIG. 6 is a flow chart illustrating an exemplary method wherein IGMP messages originating at a receiving node are used to determine if a filter needs to be added or removed. IGMP packets are network signals that provide information to switching nodes about receiving nodes to which they are attached. This type of signal is used to minimize load on the network, ensuring that a data stream is only repeated if a listener attached to the node will subscribe to it. By detecting IGMP signals transmitted by the receiving node, this method requires no repetitive polling, only passive monitoring, which accomplishes filter initiation independently of any special programming interfaces.

Referring to FIG. 6, in steps 602 and 604 the system detects receipt of an IGMP message. If an IGMP signal is detected than, in step 606, the client machine examines it to determine the entry in the SIT to which the IGMP message corresponds. In step 608, the client machine determines whether the IGMP message is a request to join a multicast group or a request to leave a multicast group.

If it is determined in step 608 that the IGMP signal is a request to join a group then, step 610, the filter state is examined. ‘Active’ filters are ignored, causing the client machine to again monitor IGMP traffic in step 602. If the filter state in step 610 is ‘inactive,’ in step 612 a filter is activated based on the filter parameters and the entry in the SIT is updated to reflect the new ‘active’ status. With the filter activated, scanning resumes in step 602.

If the IGMP message in step 608 is a request to leave the multicast group, then in step 614 the status of the SI entry to which the message corresponds is determined. In the status of the entry is ‘inactive,’ it is ignored since there is no filter to remove, and detection in step 602 resumes. If the status of the entry is ‘active’, then, in step 616, the filter is removed and the status of the entry is changed to ‘inactive.’ With the filter removed, scanning resumes in step 602.

This embodiment relies on passive detection of signals, and thus its impact on system performance is minimal.

The many features and advantages of the present invention are apparent from the detailed specification, and thus, it is intended by the appended claims to cover all such features and advantages of the invention which fall within the true spirit and scope of the invention.

Furthermore, since numerous modifications and variations will readily occur to those skilled in the art, it is not desired that the present invention be limited to the exact construction and operation illustrated and described herein, and accordingly, all suitable modifications and equivalents which may be resorted to are intended to fall within the scope of the claims.

What is claimed is:

1. A method for a receiver to detect a need to implement a filter to a multicast program, the method comprising:
examining a connection from a client machine;
retrieving a filter parameter for the connection; and
implementing the filter parameter as a filter for a multicast program.

2. The method according to claim 1 wherein the receiver is integrated with the client machine.

3. The method according to claim 1 wherein examining a connection further comprises examining a user datagram protocol (UDP) port.

4. The method according to claim 1 wherein the connection from a client machine is used to determine the filter parameter to be retrieved.

5. The method according to claim 1 wherein the filter parameter comprises a program identifier.

6. The method according to claim 1 wherein the receiver is a Digital Video Broadcast—Terrestrial receiver.

7. A method for a receiver to detect a need to remove a filter for a multicast program, the method comprising:
examining a filter;
determining a connection the filter is associated with;
examining a plurality of connections from a client machine;
removing the filter if the connection from the client machine does not correspond to the connection the filter is associated with.

8. The method according to claim 7 wherein the receiver is integrated with the client machine.

9. The method according to claim 7 wherein examining a connection further comprises examining a user datagram protocol port.

10. The method according to claim 7 wherein determining further comprises determining whether there is a connection to the client machine.

11. The method according to claim 7 wherein the receiver fetches a filter parameter from a table containing service information.

12. A method for a receiver to detect a need to implement a filter for a multicast program, the method comprising:
examining a message received from a client machine;
retrieving a filter parameter for a connection to the client machine; and
implementing the filter parameter as a filter for a multicast program.

13. The method according to claim 12 wherein the receiver is integrated with the client machine.

14. The method according to claim 12 wherein the receiver is a Digital Video Broadcast —Terrestrial receiver.

15. A method for a receiver to detect a need to remove a filter for a multicast program, the method comprising:
examining a message received from a client machine;
retrieving a filter parameter for a connection to the client machine; and
removing a filter based on the filter parameter.

16. The method according to claim 15 wherein the message is an IGMP message.

17. The method according to claim 15 wherein the receiver fetches the filter parameter from a table containing service information.

18. A method for managing a filter, the method comprising:
detecting an IGMP packet containing an instruction to join or leave a multicast group, said IGMP packet being associated with an entry in a table;
removing a filter based on a filter parameter associated with the entry in the table that corresponds to the IGMP message having the instruction to leave a multicast group; and
adding a filter based on a filter parameter associated with the entry in the table that corresponds to the IGMP packet having the instruction to enter a multicast group.

19. A method for managing a filter in a system having a service information table (SIT) comprising a plurality of entries, each entry having a port number and a filter parameter, and a User Datagram Protocol (UDP) Listener Table comprising a plurality of entries, each entry having a port number and an local internet protocol (IP) address, the method comprising:
comparing each entry in a UDP Listener Table to each entry in a SIT;
determining a filter parameter of a first type of entry, wherein the first type of entry is present in the UDP Listener Table and not present in the SIT;
implementing a filter parameter of the first type of entry as a first filter;
determining the filter parameter of a second type of entry that is present in the SIT and not present in the UDP Listener Table;
removing a second filter based on the filter parameter of the second type of entry.

20. The method according to claim 19 wherein the UDP Listener Table entry is identified as a multicast address by the local IP address.

21. A method for creating a filter for data at a multicast receiving node, the method comprising:
detecting a multicast data connection;
associating the data connection with a filter parameter;
creating a socket;
binding the socket to a port number;
fetching the filter parameter; and
accepting data from the data connection,
wherein said data is processed based on the filter parameter.

22. The method according to claim 21 wherein the multicast receiving node includes a Digital Video Broadcast—Terrestrial receiver.

23. The method according to claim 22 wherein fetching further comprises examining a table containing service information.

24. A method for removing a filter for data at a multicast receiving node, the method comprising:
detecting a data connection being closed;
associating the data connection with a filter parameter;
leaving a multicast group;
fetching the filter parameter;
removing a filter based on the filter parameter.

25. The method according to claim 24 wherein detecting further comprises continuously polling the user datagram protocol (UDP) Listener Table.

26. The method according to claim 25 wherein polling the UDP Listener Table further comprises identifying multicast data from the UDP Listener Table.

27. A method for activating a data filter in a Digital Video Broadcast—Terrestrial system having a service information table (SIT) comprising an entry having a filter parameter and a filter status, said system transmitting an IGMP message, the method comprising:
detecting a IGMP message;
retrieving a filter parameter from an SIT;
activating a filter based on the filter parameter; and
changing a filter status in the SIT.

28. A method for removing a data filter in a Digital Video Broadcast—Terrestrial system having a service information table (SIT) comprising an entry having a filter parameter, a User Datagram Packet (UDP) port number, and a filter status, said system also having a UDP Listener Table comprising an entry having a UDP port number and a local internet protocol (IP) address that indicates that said entry is a multicast connection, the method comprising:
polling a UDP Listener Table;
correlating a UDP entry with an SIT entry;
identifying an SIT entry having an active status as the filter status;
removing a data filter corresponding to a filter parameter of the identified SIT entry; and
changing the filter status of the SIT entry.

29. An article of manufacture for managing a filter in a Digital Video Broadcast—Terrestrial system having a service information table (SIT) comprising an entry having a filter parameter, and transmitting an IGMP packet containing a multicast group address and an instruction, the article comprising:
a computer readable medium including instructions for:
detecting the IGMP packet with the instruction to join or leave a multicast group;
removing the filter for the SIT entry that corresponds to the IGMP packet having the instruction to end a subscription; and
adding the filter for the SIT entry that corresponds to the IGMP packet having the instruction to begin a subscription.

30. An article of manufacture for managing a filter in a Digital Video Broadcast—Terrestrial system having a service information table (SIT) comprising an entry having a port number and a filter parameter, and a user datagram protocol (UDP) Listener Table comprising an entry having a port number and an internal internet protocol (IP) address, the article comprising:
a computer readable medium including instructions for:
finding the SIT entry that corresponds to the UDP entry having the local IP address associated with the port number of a multicast connection
removing the filter that contains the filter parameter corresponding to the SIT entry with which there is no UDP entry associated; and
activating the filter for the filter parameter that is in both tables and for which the filter is not applied.

31. The method according to claim 1 wherein the method is implemented in a wireless handheld terminal.

32. The method according to claim 18 wherein the method is implemented in a wireless handheld terminal.

33. The method according to claim 21 wherein the method is implemented in a wireless handheld terminal.

34. The method according to claim 28 wherein the method is implemented in a wireless handheld terminal.
